(19) United States
(12) Patent Application Publication
(10) Pub. No.: US 2026/0009918 A1
(43) Pub. Date: Jan. 8, 2026

(54) SYSTEM AND METHODS FOR HEXAGONAL PHASE ENCODING FOR MARINE VIBRATORS

(71) Applicant: SCHLUMBERGER TECHNOLOGY CORPORATION, Sugar Land, TX (US)

(72) Inventor: Claudio BAGAINI, Aosta (FR)

(21) Appl. No.: 19/123,773

(22) PCT Filed: Dec. 13, 2023
(86) PCT No.: PCT/US2023/083840

§ 371 Date: Apr. 24, 2025

Related U.S. Application Data
(60) Provisional application No. 63/387,835, filed on Dec. 16, 2022.

(51) Int. Cl. G01V 1/30; G01V 1/34

(52) U.S. Cl. CPC G01V 1/307; G01V 1/345

(57) ABSTRACT

The disclosed method includes simultaneously transmitting, using a first seismic source and a second seismic source: a first signal from the first seismic source; and a second signal from the second seismic source. The method also includes: determining, based on detecting the simultaneously transmitted first signal and second signal, wave number data; and designating, based on the wave number data, a position of the first seismic source relative to the second seismic source. The method also includes: determining, based on the position of the first seismic source relative to the second seismic source, optimal phase modulation of the simultaneously transmitted first signal and second signal that enable deterministic separation of the simultaneously transmitted first signal and second signal in the plane wave domain; and using the optimal phase modulation to resolve or separate wavefields included in the simultaneously transmitted first signal and second signal in the plane wave domain.

### CROSS-REFERENCE TO RELATED APPLICATIONS

This application claims priority to U.S. Provisional Patent App. No. 63/387,835 filed on Dec. 16, 2022, and titled “SYSTEM AND METHODS FOR HEXAGONAL PHASE ENCODING FOR MARINE VIBRATORS,” which is incorporated herein by reference in its entirety for all purposes.

### INTRODUCTION

This disclosure relates to techniques for arranging seismic data sources (e.g., seismic signal transmitters) that enable simultaneous transmission of a plurality of seismic signals which are accurately resolvable or separable when detected or received.

### BACKGROUND

In the seismic data acquisition and processing space, there is a need to develop techniques and procedures that maximize or otherwise optimize bandwidth usage as well as minimize time durations associated with seismic signal transmissions, detections, and analysis and thereby improve development (e.g., energy development) operations that depend on seismic data.

### SUMMARY

Disclosed are methods, systems, and computer programs that facilitate optimally arranging two or more seismic sources to separate wavefields generated therefrom. According to an embodiment, a method for arranging two or more seismic sources to separate wavefields comprises: determining: a first seismic source included in two or more seismic sources that transmits a first signal; and a second seismic source included in the two or more seismic sources that transmits a second signal. The method further includes simultaneously transmitting, using the first seismic source and the second seismic source: the first signal from the first seismic source; and the second signal from the second seismic source. The method also includes determining, based on detecting the simultaneously transmitted first signal and second signal, wave number data indicating spatial frequency data that establish a proximal relationship of first plane wave event data associated with the first signal and second plane wave event data associated with the second signal, wherein the spatial frequency data comprises: first space sampling data associated with a first dimension of a plane wave domain; and second space sampling data associated with a second dimension of the plane wave domain. Moreover, the method includes designating, based on the wave number data, a position of the first seismic source relative to the second seismic source; and determining, during a survey and based on the position of the first seismic source relative to the second seismic source, optimal phase modulation of the simultaneously transmitted first signal and second signal that enable deterministic separation of the simultaneously transmitted first signal and second signal in the plane wave domain. In addition, the method includes determining, based on the optimal phase modulation, the first plane wave event data and the second plane wave event data, such that the phase modulation yields a representation of the first signal and the second signal in the plane wave domain as a hexagon. Furthermore, the method includes resolving, based on the first plane wave event data and the second plane wave event data, wavefields associated with the first seismic source and the second seismic source and thereby generate resolved plane wave event data; and arranging, based on the resolved plane wave event data, the first seismic source and the second seismic source to have a distance associated with the position of the first seismic source relative to the second seismic source.

In other embodiments, a system and a computer program can include or execute the method described above. These and other implementations may each optionally include one or more of the following features.

In some embodiments, the first seismic source and the second seismic source comprise vibrators used for seismic exploration. Moreover, the vibrators can comprise land-based vibrators and/or marine vibrators.

The plane wave domain, in exemplary implementations comprises: a domain indicating a three-dimensional Fourier transform of the detected simultaneously transmitted first signal and second signal; or constant frequency slices of the three-dimensional Fourier transform.

It is appreciated that the plane wave domain comprises one of a Fourier domain (e.g., a multi-dimensional Fourier transform) or a Radon domain (e.g., Radon multidimensional transform)

In some embodiments, all seismic sources comprised in the two or more seismic sources are configured such that their representation in the plane wave domain is hexagonal in structure.

In addition, the distance associated with the position of the first seismic source relative to the second seismic source is determined based on a separation threshold value that optimizes resolving the first plane wave event data associated with the first signal relative to the second plane wave event data associated with the second signal.

Furthermore, the separation threshold value may be determined based on simultaneously transmitting a plurality of signals including the first signal and the second signal from the two or more seismic sources. In some cases, the separation threshold value indicates a number of resolvable plane wave event data associated with the first seismic source and the second seismic source.

In addition, the first space sampling data comprises a first space sampling value that is equivalent to a second space sampling value comprised in the second space sampling data. In such cases, the separation threshold value indicates a maximum number of resolvable plane wave event data associated with the two or more seismic sources.

In some embodiments, the first seismic source is comprised in a first marine vibrator array coupled to a first vessel while the second seismic source is coupled to a second marine vibrator array coupled to a second vessel. In other embodiments, the first seismic source and the second seismic source are coupled to the same vessel.

Furthermore, the detected simultaneously transmitted first signal and second signal can comprise seismic data captured as part of energy development operations. For example, the seismic data may be comprised in the resolved plane wave event data which may be associated with a resource site including oil fields, oil basins, gas reservoirs, or other resources in the subsurface.

In exemplary implementations, the method disclosed may further include modeling a subsurface of a resource site using the resolved plane wave event data to generate a multi-dimensional visualization of the subsurface of the resource site.

### BRIEF DESCRIPTION OF THE DRAWINGS

The disclosure is illustrated by way of example, and not by way of limitation in the figures of the accompanying drawings in which like reference numerals are used to refer to similar elements. It is appreciated that various features may not be drawn to scale and the dimensions of various features may be arbitrarily increased or reduced for clarity of discussion. Further, it is contemplated that features of one or more embodiments may be incorporated in other embodiments without additional recitation.

FIG. 1A depicts an exemplary computing or network system within which the disclosed methods, systems, and computer programs can be implemented according to some embodiments of this disclosure.

FIGS. 1B-1F illustrate exemplary schematic views of a resource site for which the disclosed methods, systems, and computer programs may be executed according to some embodiments of this disclosure.

FIG. 1G illustrates a resource site for performing production operations in accordance with implementations of various technologies and techniques described herein.

FIG. 1H-A illustrates a side view of a marine-based survey of a subterranean subsurface in accordance with one or more implementations of various techniques described herein.

FIG. 1H-B depicts a marine electromagnetic survey system in accordance with some embodiments of this disclosure.

FIG. 1I depicts a marine system including a rig, a plurality of vessels, and one or more acoustic receivers.

FIGS. 1J and 1K illustrate signal representations in two dimensions of a plane wave domain.

FIG. 2 is a schematic representation of a two-dimensional slice of signal representations in a plane wave domain.

FIG. 3 illustrates a schematic representation of the elements associated with the disclosed techniques.

FIG. 4 illustrates seismic data that has been recorded or otherwise received or detected by a common receiver in the middle of a source grid for the “green” Sg sources described herein.

FIG. 5 illustrates frequency slices when signals are emitted by the “blue” source described herein according to a phase encoding scheme.

FIG. 6 provides an exemplary detailed workflow 600 for methods, systems, and computer programs that facilitate arranging two or more seismic sources to separate wavefields generated therefrom.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed technology. However, it will be apparent to one of ordinary skill in the art that the disclosed embodiments may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both objects or steps, respectively, but they are not to be considered the same object or step.

The terminology used in the description of the disclosed techniques is for the purpose of describing particular embodiments and is not intended to be limiting. As used in the description of this disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this disclosure, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Computing Systems

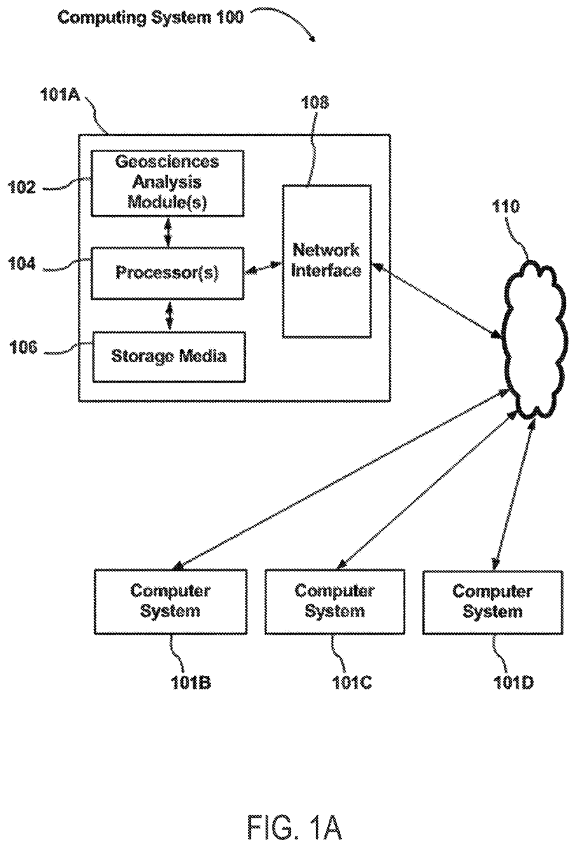

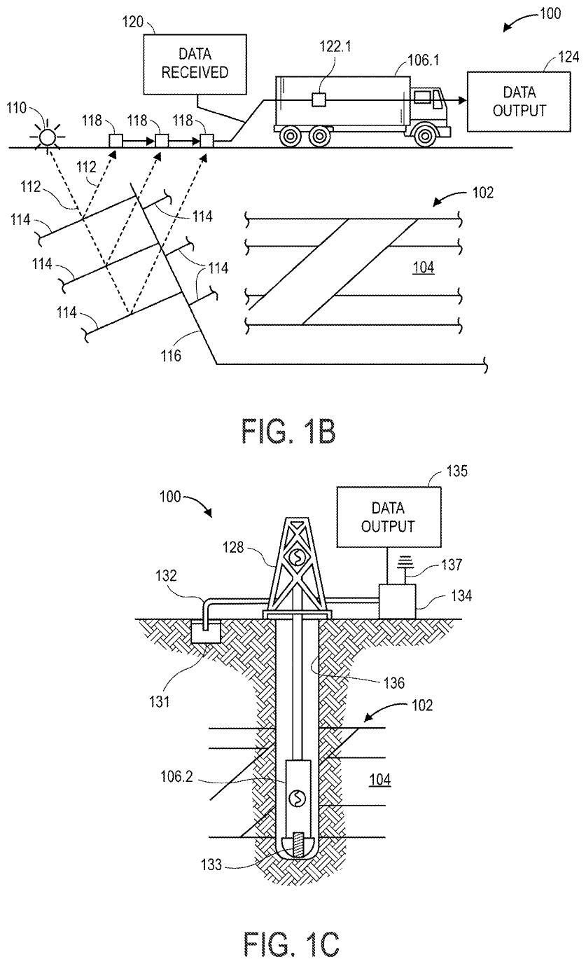

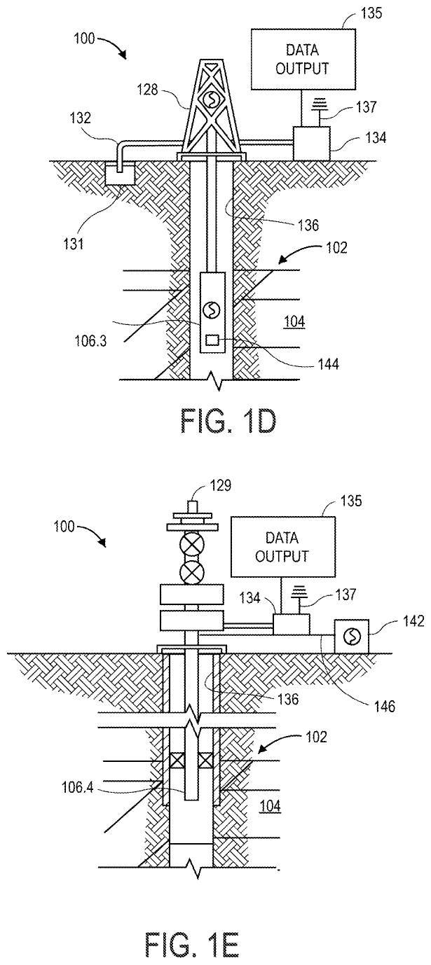

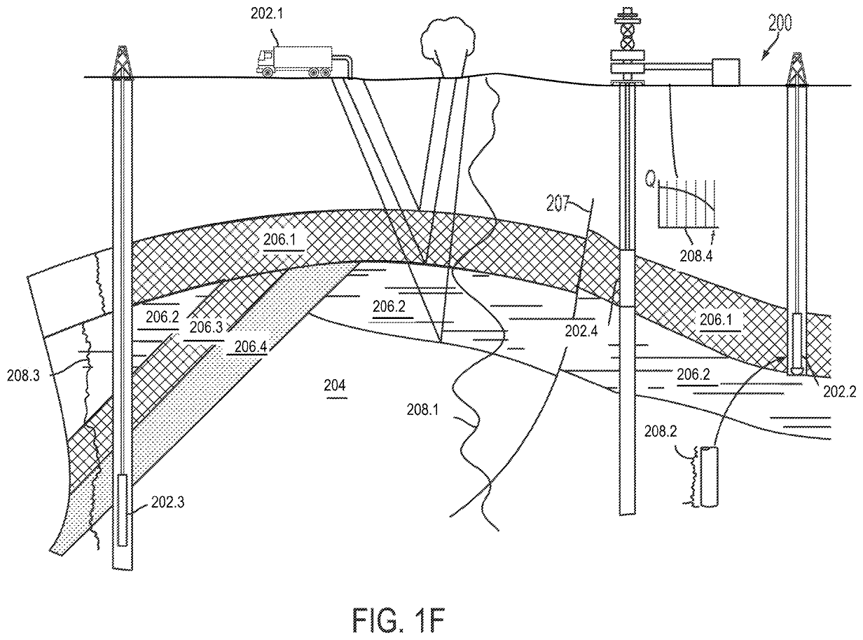

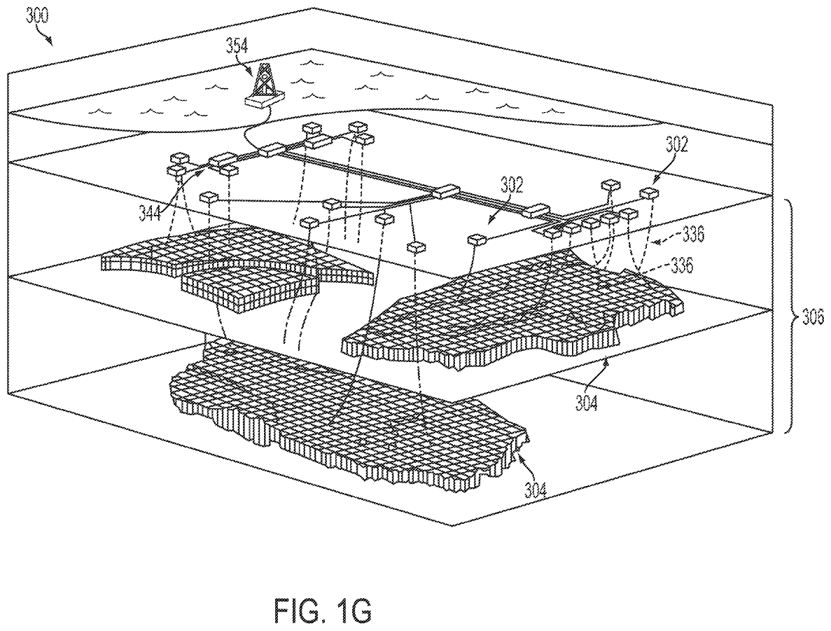

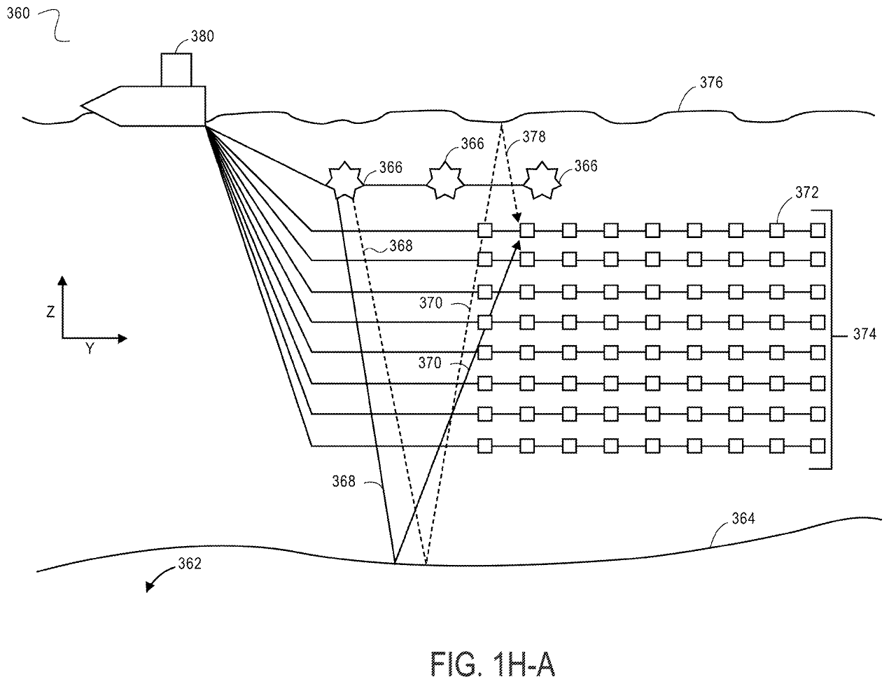

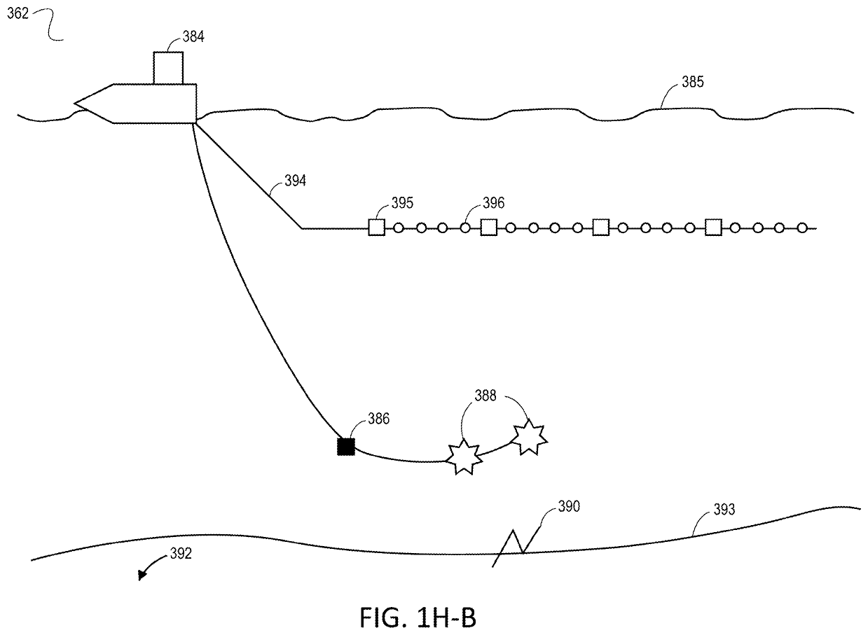

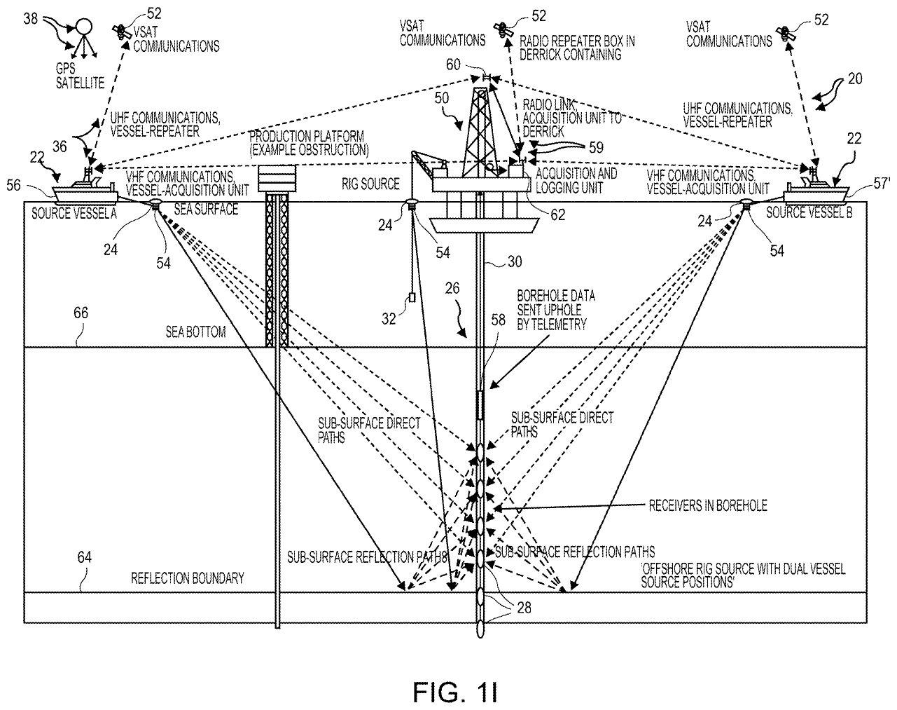

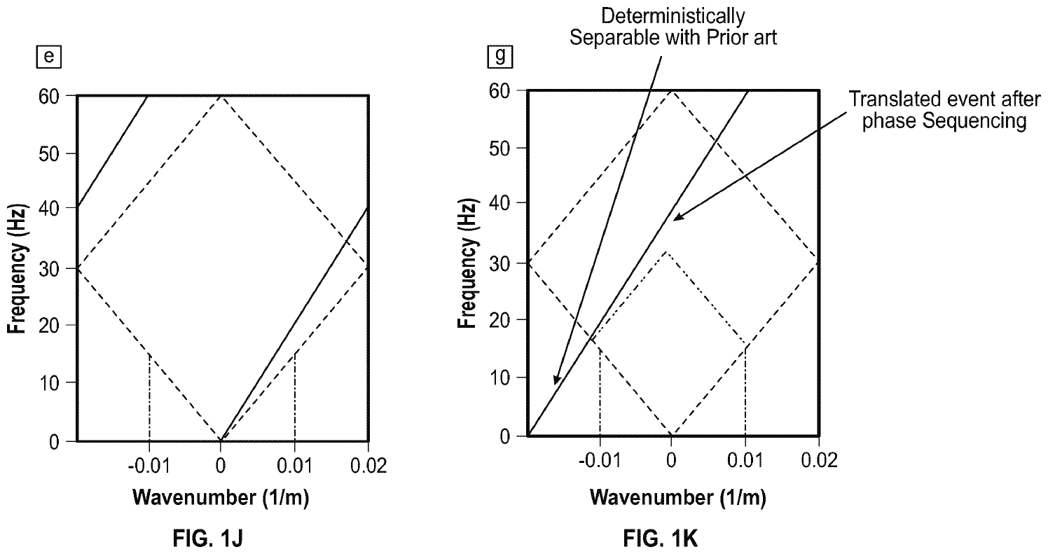

FIG. 1A depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, the geosciences analysis module 102 (e.g., signal processing engine) executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D. It is appreciated that computer systems 101B, 101C and/or 101D may or may not share the same architecture as computer system 101A, and may be located in different physical locations relative to each other or to computer system 101A. For example, computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network and may use portions of public networks and may include local or remote storage and/or application processing capabilities (e.g., cloud computing).

A processor 104 can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1A storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media can be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It is appreciated that computer system 101A is one example of a computing system, and that computer system 101A may have more or fewer components than those shown and may combine additional components not depicted in the example embodiment of FIG. 1A, and/or computer system 101A may have a different configuration or arrangement of components relative to the components depicted in FIG. 1A. The various components shown in FIG. 1A may be implemented in hardware, software, or a combination of both, hardware and software, including one or more signal processing engines and/or application specific integrated circuits.

It is appreciated that while no user input/output peripherals are illustrated with respect to computer systems 101A, 101B, 101C, and 101D, many embodiments of computing system 100 include computer systems with keyboards, mice, touch screens, displays, and other user peripheral systems or other input-output systems. Some computer systems in use in computing system 100 may be desktop workstations, laptops, tablet computers, smartphones, server computers, etc.

Further, the steps in the processing methods described herein may be implemented by running one or more functional modules in an information processing apparatus such as general-purpose processors or application specific chips, such as ASICs, FPGAs, PLDs, or other appropriate devices. These modules, combinations of these modules, and/or their combination with general hardware are included within the scope of protection of the disclosed subject-matter.

FIGS. 1B-1F illustrate exemplary schematic views of a resource site (e.g., an oilfield or gas reservoir) having subterranean formation 102 containing reservoir 104 therein in accordance with implementations of various technologies and techniques described herein. FIG. 1B illustrates a survey operation being performed by a survey tool, such as seismic truck 106.1, to measure properties of the subterranean formation. The survey operation is a seismic survey operation for producing sound vibrations. In FIG. 1B, one such sound vibration, e.g., sound vibration 112 is generated by source 110 such that the sound vibration reflects off horizons 114 in the earth formation 116. A set of sound vibrations may be received by sensors (e.g., geophone-receivers 118) situated on the earth's surface. The data received 120 may be provided as input data to a computer 122.1 of a seismic truck 106.1, and responsive to the input data, computer 122.1 may generate seismic data output 124. This seismic data output may be stored, transmitted or further processed as the case may require.

FIG. 1C illustrates a drilling operation being performed by drilling tools 106.2 suspended by rig 128 and advanced into subterranean formations 102 to form wellbore 136. Mud pit 130 may be used to draw drilling mud into the drilling tools via flow line 132 to circulate drilling mud down to the drilling tools, then up the wellbore 136 and back to the surface. The drilling mud may be filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools may be adapted for measuring downhole properties using logging systems while drilling. The logging systems may also be adapted for taking core (e.g., soil) sample 133 as shown according to some embodiments.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield 100 to collect data relating to various oilfield operations as described previously. In some embodiments, a sensor may be positioned in one or more locations around the drilling tools and/or at rig 128 to measure drilling parameters, such as weight on bit, torque on bit, pressures, temperatures, flow rates, compositions, rotary speed, and/or other parameters of the field operation. The sensors may also be positioned at one or more locations in the circulating system according to some embodiments.

Drilling tools 106.2 may include a bottom hole assembly (BHA) (not shown), near the drill bit (e.g., within several drill collar lengths from the drill bit). The bottom hole assembly may also include systems or devices for measuring, processing, and storing information, as well as communicating with surface unit 134. The bottom hole assembly may further include drill collars for performing various other measurement functions.

The bottom hole assembly may include a communication subassembly that communicates with surface unit 134. The communication subassembly may be adapted to send signals to and receive signals from the surface using a communications channel such as mud pulse telemetry, electro-magnetic telemetry, wireless technology, or a wired drill pipe communications system. The communication subassembly may include, for example, a transmitter that generates a signal, such as an acoustic or electromagnetic signal, which is representative of the measured drilling parameters. It is appreciated that a variety of telemetry systems may be employed, such as wired drill pipe, electromagnetic or other telemetry systems.

According to some embodiments, the wellbore may be drilled according to a drilling plan that is established prior to drilling. The drilling plan may set forth equipment data, pressure data, trajectory information and/or other data parameters that define or otherwise specify the drilling process for a given wellsite associated with the resource site (e.g., oilfield 100). The drilling operation may then be performed according to the drilling plan. However, as information is gathered, the drilling operation may be optimized or updated to, for example, deviate from the drilling plan to satisfy efficient drilling operations. Additionally, as drilling or other operations are performed, the subsurface conditions may change. A geological model (e.g. earth model) associated with the resource site may also updated or adjusted to account for the new information being collected about the resource site.

The data gathered by the sensors disposed about the resource site may be received by surface unit 134 and/or other data collection sources for analysis or other processing. The data collected by the sensors may be used alone or in combination with other data. The data may be received by, and/or stored in one or more databases and/or transmitted to an onsite location or an offsite as the case may require. The data may be historical data, real-time data, or combinations thereof. The real-time data may be used in real-time operations, or stored for later use. The real-time data may also be combined with historical data or other inputs for further analysis. According to some embodiments, the data collected at the resource site may be stored in separate databases, or combined within a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1D illustrates a wireline operation being performed using wireline tool 106.3 suspended by rig 128 and into wellbore 136 of FIG. 1C. Wireline tool 106.3 may be adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1B. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about the resource site (e.g., oilfield 100) to collect data relating to various field operations as described previously. According to some embodiments, the sensor may be positioned within wireline tool 106.3 to measure downhole parameters which relate to, for example porosity, permeability, fluid composition and/or other parameters of the field operation.

FIG. 1E illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146. According to some embodiments, sensors, such as gauges, may be positioned about oilfield 100 to collect data relating to various field operations as described previously. For example, the sensors may be positioned within production tool 106.4 or within or about an associated equipment, such as Christmas tree 129, gathering network 146, surface facility 142, and/or the production facility, to measure fluid parameters, such as fluid composition, flow rates, pressures, temperatures, and/or other parameters of the production operation. In some embodiments, one or more injection wells may be fluidly coupled to the reservoir for added fluid recovery. Furthermore, one or more gathering facilities may be operatively connected to one or more of the wellsites within the resource site (e.g., oilfield 100) for selectively collecting downhole fluids from the wellsite(s).

While FIGS. 1C-1E illustrate tools used to measure properties of a resource site (e.g., oilfield 100), it is appreciated that the tools may be used in connection with non-oilfield operations, such as gas fields, mineral mines, aquifers, storage, or other subterranean facilities. Also, while certain data acquisition tools are depicted, it is appreciated that various measurement tools capable of sensing parameters, such as seismic two-way travel time, density, resistivity, production rate, etc., of the subterranean formation and/or its geological formations may be used. Various sensors may be located at various positions along the wellbore and/or coupled to or be situated within the monitoring tools to collect and/or monitor the desired data. Other sources of data may also be provided from offsite locations to supplement or otherwise enhance data captured at the resource site.

The field configurations of FIGS. 1B-1E are intended to provide a brief description of an example of a resource site usable with oilfield application frameworks. Part of, or the entirety, of oilfield 100 may be on land, water, and/or sea. Also, while data associated with a single resource site is indicated as being measured and/or processed at a single location within these figures, oilfield applications may be used with any combination of one or more resource sites (e.g., a plurality of oilfields 100), one or more processing facilities, and one or more similar or dissimilar wellsites.

FIG. 1F illustrates a schematic view, and in particular, a partial cross section of the resource site (e.g., referenced as oilfield 200 in the figure) that has data acquisition tools 202.1, 202.2, 202.3 and 202.4 positioned at various locations about the resource site for collecting data of subterranean formation 204 in accordance with implementations of various technologies and techniques described herein. Data acquisition tools 202.1-202.4 may be the same as data acquisition tools 106.1-106.4 of FIGS. 1B-1E, respectively, or others not depicted. As shown, data acquisition tools 202.1-202.4 may generate data plots or measurements 208.1-208.4, respectively. These data plots are depicted along the resource site (e.g., oilfield 200) to demonstrate the data generated by the various operations.

Data plots 208.1-208.3 are examples of static data plots that may be generated by data acquisition tools 202.1-202.3, respectively; however, it is appreciated that data plots 208.1-208.3 may include data plots that are updated in real time or near real-time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that can provide, for example, a resistivity measurement or some other measurements of the formation at various depths. Also shown in the figure is a production decline curve or graph 208.4 which indicates a dynamic data plot of the fluid flow rate over time. The production decline curve can provide the production rate as a function of time. As fluid flows through the wellbore, measurements may be taken of fluid properties, such as flow rates, pressures, composition, etc., according to some embodiments.

According to some implementations, other data may also be collected or captured or associated with the resource site, such as historical data, user input data, economic data, and/or other sensor data and/or other parametric data associated with one or more models of the resource site. As described below, static and dynamic measurements may be analyzed and/or used to generate models of the subterranean formation to determine characteristics thereof. Similar or dissimilar measurements may also be used to measure or track changes a geological formation associated with the resource over time.

In some embodiments, the subterranean structure 204 may have a plurality of geological formations 206.1-206.4. As shown in FIG. 1F, this geological formation may comprise several formations or layers, including a shale layer 206.1, a carbonate layer 206.2, a shale layer 206.3 and a sand layer 206.4. A fault 207 may extend through the shale layer 206.1 and the carbonate layer 206.2. In addition, the static data acquisition tools may be adapted to take measurements and detect characteristics of the aforementioned formations and/or other geological structures within the subterranean structure 204. While a specific subterranean formation with specific geological structures is depicted FIG. 1F, it is appreciated that the resource site (e.g., oilfield 200) may contain a variety of geological structures and/or formations, sometimes having extreme complexity than those depicted which can be characterized using, for example, seismic data (e.g., resolved seismic data from two or more seismic sources). In some locations within the subterranean structure 204 may be below the water line such that fluid may occupy pore spaces of the one or more formations depicted. Each of the measurement devices may be used to measure properties of the formations and/or other geological features within the subterranean structure 204. While each acquisition tool is shown as being in specific locations at the resource site (e.g., oilfield 200), it is appreciated that one or more types of measurements may be taken at one or more locations across one or more fields or other locations for comparison and/or for analysis and/or for integration with data captured at the resource site. The data captured from various sources, such as the data acquisition tools of FIG. 1F, may then be processed and/or evaluated. In some embodiments, seismic data may be displayed in a static data plot 208.1 from the data acquisition tool 202.1 and may be used to determine characteristics of the subterranean formations and other geological features associated with the resource site. The core data shown in the static plot 208.2 and/or log data from the well log 208.3 may be used to determine various characteristics of the subterranean formation. The production data from graph 208.4 may also be used to determine fluid flow reservoir characteristics as the case may require. In some embodiments, the captured data from the resource site may be used to generate models that facilitate additional analysis of the subterranean structure 204 of the resource site.

FIG. 1G illustrates a resource site (e.g., oilfield 300) for performing production operations in accordance with implementations of various technologies and techniques described herein. As shown, the resource site has a plurality of wellsites 302 operatively connected to central processing facility 354. The resource site configuration of FIG. 1G is not intended to limit the scope of the oilfield application system. Part, or all, of the resource site may be on land and/or sea. Also, while a single resource site with a single processing facility and a plurality of wellsites is depicted, any combination of one or more resource sites, one or more processing facilities 354 and one or more wellsites 302 may be present according to some embodiments.

Each wellsite 302 may have equipment associated with one or more wellbores 336 within the subterranean formation 306 of the resource site. In particular, the wellbores 336 may extend through or into the subterranean formations 306 including reservoirs 304. These reservoirs 304 may contain liquid and/or gaseous fluids, such as hydrocarbons. In some embodiments, the wellsites 302 may draw fluid to and/or from the reservoirs and may pass said fluids to processing facilities via surface networks 344. The surface networks 344 may have tubing and control mechanisms for controlling the flow of fluids from the wellsite 302 to processing facility 354.

Attention is now directed to FIG. 1H-A, which illustrates a side view of a marine-based survey 360 of a subterranean subsurface 362 in accordance with one or more implementations of various techniques described herein. Subsurface 362 may include seafloor surface 364. Seismic sources 366 may include marine sources such as vibroseis or airguns, which may propagate seismic waves 368 (e.g., energy signals) into the Earth over an extended period of time or at a nearly instantaneous energy level provided by impulsive or pulse sources. The seismic waves may be propagated by marine sources as a frequency sweep signal. For example, marine sources of the vibroseis type may initially emit a seismic wave at a low frequency (e.g., 5 Hz) and increase the seismic wave frequency to a high frequency (e.g., 80-90 Hz) over time. In some embodiments, the component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data. In some implementations, each streamer (e.g., comprised in the streamer array 374) may include streamer steering devices such as a bird, a deflector, a tail buoy and the like, which are not illustrated in FIG. 1H-A. The streamer steering devices may be used to control the position of the streamers (e.g., comprised in the streamer array 374) in accordance with the techniques described herein. In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is may be referred to as the downward reflection point.

According to some implementations, the electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). For instance, surveys may be of formations deep beneath the surface. The formations may typically include multiple reflectors, some of which may include dipping events, and may generate multiple reflections (e.g., including wave conversion) for receipt by the seismic receivers 372. In one implementation, the seismic data may be processed to generate a seismic image of the subsurface 362.

Typically, marine seismic acquisition systems may tow each streamer comprised in the streamer array 374 to the same depth (e.g., 5-10 m) within a body of water (e.g., the sea). However, marine based survey 360 may tow each streamer comprised in streamer the array 374 to a plurality of different depths as indicated in FIG. 1H-A such that seismic data may be acquired and processed in a manner that avoids the effects of destructive interference due to sea-surface ghost waves. For instance, marine-based survey 360 of FIG. 1H-A illustrates eight streamers towed by vessel 380 at eight different depths. The depth of each streamer may be controlled and maintained using the birds disposed on each streamer.

FIG. 1H-B depicts a marine electromagnetic survey system 382 in accordance with implementations of various technologies described herein. The electromagnetic survey system 382 may use controlled-source electromagnetic (CSEM) survey techniques, but other electromagnetic survey techniques may also be used. Marine electromagnetic surveying may be performed by a survey vessel 384 that moves in a predetermined pattern along the surface 385 of a body of water such as a lake, a river, or the ocean. The survey vessel 384, according to some embodiments, is configured to pull a towfish (e.g., an electric source) 386, which is connected to a pair of electrodes 388. During the survey, the vessel may stop and remain stationary for a period of time while obtaining measurements, while in some circumstances, the vessel may remain underway while obtaining measurements.

At the source 386, a controlled electric current may be generated and sent through the electrodes 388 into the water body. For instance, the electric current generated may comprise signals with frequency ranges of about 0.01 Hz and about 20 Hz. The current associated with said signals can create an electromagnetic field 390 in the subsurface 392 to be surveyed below the water floor (e.g., sea floor 393). The electromagnetic field 390 may also be generated by magneto-telluric currents instead of the source 386. The survey vessel 384 may also be configured to tow a sensor cable 394. The sensor cable 394 may be a marine towed cable. The sensor cable 394 may contain sensor housings 395, telemetry units 396, and current sensor electrodes (not illustrated). The sensor housings 395 may contain voltage potential electrodes for measuring the electromagnetic field 390 strength created in the subsurface area 392 during the surveying period. The current sensor electrodes may be used to measure electric field strength in directions transverse to the direction of the sensor cable 394 (the y- and z-directions). The telemetry units 395 may contain circuitry configured to determine the electric field strength using the electric current measurements made by the current sensor electrodes. While a marine-based electromagnetic survey is described in regard to FIG. 1H-B, a land-based electromagnetic survey may also be used in accordance with implementations of various techniques described herein.

Attention is now directed to FIG. 1I that depicts an embodiment of seismic system 20 in which a plurality of tow-vessels 22 are employed to enable seismic profiling including, for example, three-dimensional vertical seismic profiling or rig/offset vertical seismic profiling. In FIG. 1I, a marine system is illustrated as including a rig 50, a plurality of vessels 22, and one or more acoustic receivers 28. Although a marine system is illustrated, other embodiments of the disclosure may not be limited to this example. It is appreciated that the disclosed approach may be implemented for land or onshore energy development systems. However, offshore systems are described herein to simplify the disclosure and to facilitate the explanation of the disclosed techniques.

Although two vessels 22 are illustrated in FIG. 1I, a single vessel 22 with multiple source arrays 24 or multiple vessels 22 each with single or multiple sources 24 may be used. In some applications, at least one source/source array 24 may be located on the rig 50 as represented by the rig source in FIG. 1I. As the vessels 22 travel on predetermined or systematic paths, their locations may be recorded through the use of navigation system 36. In some cases, the navigation system 36 uses a global positioning system (GPS) 38 to record the position, speed, direction, and other parameters of the tow-vessels 22.

As illustrated, the global positioning system 38 may use or work in cooperation with satellites 52 which operate on a suitable communication protocol, e.g., VSAT communications. The VSAT communications may be used, among other things, to supplement VHF and UHF communications. The GPS information can be independent of the VSAT communications and may be input to a computer processing system or other suitable processors to predict the future movement and position of the vessels 22 based on real-time information. In addition to predicting future movements, the computer processing system can also be used to provide directions and coordinates as well as to determine initial shot times, as described above. A control system associated with the vessels 22 can effectively use the computer processing system in cooperation with a source controller and synchronization unit to synchronize the sources 24 with the downhole data acquisition system 26.

As illustrated, the one or more vessels 22 may each tow one or more acoustic sources/source arrays 24. The source arrays 24 include one or more seismic signal generators 54 including, for example, air guns, configured to create a seismic/sonic disturbance. In the embodiment illustrated, the tow-vessels 22 comprise a master source vessel 56 (Vessel A) and a slave source vessel 57 (Vessel B). However, other numbers and arrangements of tow-vessels 22 may be employed to accommodate the parameters of a given seismic profiling application. For example, one source 24 may be mounted at rig 50 or at another suitable location, and both vessels 22 may serve as slave vessels with respect to the source 24 or with respect to a source at another location.

However, a variety of source arrangements and implementations may be provided as desired for a given application. When using dithered timing between the sources, for example, the master and slave locations of the sources can be adjusted according to the parameters of the specific seismic profiling application. In some applications, one of the source vessels 22 (e.g., source vessel A in FIG. 1I) may serve as the master source vessel while the other source vessel 22 serves as the slave source vessel with dithered firing. However, an alternate source vessel 22 (e.g., source vessel B in FIG. 1I) may serve as the master source vessel while the other source vessel 22 serves as the slave source vessel with dithered firing.

Similarly, the source 24 may serve as the master source while one of the source vessels 22 (e.g., vessel A) serves as the slave source vessel with dithered firing. The source 24 also may serve as the master source while the other source vessel 22 (e.g., vessel B) serves as the slave source vessel with dithered firing. In some applications, the source 24 may serve as the master source while both of the source vessels 22 serve as slave source vessels each with dithered firings. These and other arrangements may be used in achieving the desired synchronization of sources 24 with the downhole acquisition system 26.

The acoustic receivers 28 of data acquisition system 26 may be deployed in borehole 30 via a variety of delivery systems, such as wireline delivery systems, slickline delivery systems, and other suitable delivery systems. Although a single acoustic receiver 28 could be used in the borehole 30, the illustrated embodiment comprises a plurality of receivers 28 that may be located in a variety of positions and orientations. The acoustic receivers 28 may be configured for sonic and/or seismic reception. Additionally, the acoustic receivers 28 may be communicatively coupled with processing equipment 58 located downhole. By way of example, processing equipment 58 may comprise a telemetry system for transmitting data from acoustic receivers 28 to additional processing equipment 59 located at the surface, e.g., on the rig 50 and/or vessels 22.

Depending on the specifics of a given data communication system, examples of surface processing equipment 59 may comprise a radio repeater 60, an acquisition and logging unit 62, and a variety of other and/or additional signal transfer components and signal processing components. The radio repeater 60 along with other components of processing equipment 59 may be used to communicate signals, e.g., UHF and/or VHF signals, between vessels 22 and rig 50 and to enable further communication with downhole data acquisition system 26.

It should be noted the UHF and VHF signals can be used to supplement each other. In general, the UHF band supports a higher data rate throughput but can be susceptible to obstructions and has less range. The VHF band is less susceptible to obstructions and has increased radio range but its data rate throughput is lower. In FIG. 1I, for example, the VHF communications are illustrated as “punching through” an obstruction in the form of a production platform.

In some applications, the acoustic receivers 28 are coupled to surface processing equipment 59 via a hardwired connection. In other embodiments, wireless or optical connections may be employed. In still other embodiments, combinations of coupling techniques may be employed to relay information received downhole via the acoustic receivers 28 to an operator and/or control system (e.g., control system 34) located at least in part at the surface.

In addition to providing raw or processed data uphole to the surface, the coupling system, e.g., downhole processing equipment 58 and surface processing equipment 59, may be designed to transmit data or instructions downhole to the acoustic receivers 28. For example, the surface processing equipment 59 may comprise a synchronization unit which coordinates the firing of sources 24, e.g., dithered (delayed) source arrays, with the acoustic receivers 28 located in borehole 30. According to some embodiments, the synchronization unit uses a coordinated universal time system to ensure accurate timing. In some cases, the coordinated universal time system is employed in cooperation with global positioning system 38 to obtain coordinated universal time (UTC) data from the global positioning system (GPS) receivers of GPS system 38.

FIG. 1I illustrates one example of a system for performing seismic profiling that can employ simultaneous or near-simultaneous acquisition of seismic data. By way of example, the seismic profiling may comprise three-dimensional vertical seismic profiling but other applications may use rig/offset vertical seismic profiling or seismic profiling employing walkaway lines. An offset source can be provided by a source 24 located on rig 50, on a stationary vessel 22, and/or on another stationary vessel or structure.

As an example, the overall seismic system 20 may employ various arrangements of sources 24 on vessels 22 and/or rig 50 with each location having at least one source/source array 24 to generate acoustic source signals. The acoustic receivers 28 of downhole acquisition system 26 are configured to receive the source signals, at least some of which are reflected off a reflection boundary 64 located beneath a sea bottom 36. The acoustic receivers 28 generate data streams that are relayed uphole to a suitable processing system (e.g., a computing processing system), via downhole telemetry/processing equipment 58.

While the acoustic receivers 28 generate data streams, the navigation system 36 determines a real-time speed, position, and direction of each vessel 22 and also estimates initial shot times accomplished via signal generators 54 of the appropriate source arrays 24. The source controller 42 may be part of surface processing equipment 59 (located on rig 50, on vessels 22, or at other suitable locations) and is designed to control firing of the acoustic source signals so that the timing of an additional shot time (e.g., a shot time via slave vessel 57) is based on the initial shot time (e.g., a shot time via master vessel 56) plus a dither value (e.g., signal phase value).

The synchronization unit referenced above, for example, of the surface processing equipment 59, can coordinate the firing of dithered acoustic signals (e.g., altered phase signals) with recording of acoustic signals by the downhole acquisition system 26. The computing processor system may be configured to separate a data stream of the initial shot and a data stream of the additional shot via a coherency filter. As discussed above, however, other embodiments may employ pure simultaneous acquisition and/or may not perform separation of the data streams. In such cases, the dither may be effectively set to a zero value.

After an initial shot time at T=0 (T0) is determined, subsequent firings of acoustic source arrays 24 may be offset by a dither (e.g., phase value). The dithers can be positive or negative and sometimes are created as pre-defined random delays. Use of dithers facilitates the separation of simultaneous or near-simultaneous datasets to simplify the data processing. The ability to have the acoustic source arrays 24 fire in simultaneous or near-simultaneous patterns reduces the overall amount of time used for three-dimensional vertical seismic profiling source acquisition. This, in turn, reduces rig time. As a result, the overall cost of the seismic operation is reduced, rendering the data intensive process much more accessible and efficient.

If the acoustic source arrays used in the seismic data acquisition are widely separated, the difference in move-outs across the acoustic receiver array of the wave fields generated by the acoustic sources 24 can be sufficient to obtain a clean data image via processing the data without further special considerations (e.g., minimizing the use of sophisticated hardware with associated costs and complexities). However, even when the acoustic sources 24 are substantially co-located in time, data acquired by any of the methods involving dithering of the firing times of the individual sources 24 described herein can be processed to a formation image leaving hardly any artifacts in the final image. This is accomplished by taking advantage of the incoherence of the data generated by one acoustic source 24 when seen in the reference time of the another acoustic source 24.

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, subsurface models, simulation results, ensembles of simulation results, economic models, uncertainty estimates, and the like, may be refined in an iterative fashion; this concept is applicable to the procedures, methods, techniques, and workflows as discussed herein. This iterative refinement can include use of feedback loops executed on a periodic basis, such as at a computing device (e.g., computing system 100, FIG. 1A), and/or through manual control by a user who may make determinations regarding whether a given step, action, template, or model has become sufficiently accurate.

Marine seismic acquisition and processing techniques are described herein. Specifically, some examples of the techniques can be used to acquire and process marine seismic data with a method that belongs to a family of simultaneous source acquisitions.

Some examples of the disclosed approach relate to how to rapidly acquire data with vibrators (e.g., land-based or marine vibrators) that are activated at or about the same time without affecting data quality. Some examples of the techniques exploit the phase control, which is a feature of vibrators. The optimum way of acquiring marine data at or about the same time according to examples of the techniques described herein is based on an encoding scheme (e.g., a phase encoding scheme) that is designed for each marine vibrator used in the survey.

In some examples, an efficient way of packing a circularly bandlimited signal in a double wavenumber domain (referred to herein as kₓ−k_{y} domain) derived from a plane wave domain is the hexagonal layout. Techniques described herein relate in part to how to “densely populate” the kₓ−k_{y} domain with an hexagonal layout when two or more are sources are activated at or about the same time.

The method of phase sequencing enables deterministic or non-deterministic separation of seismic signals up to absolute values of the wavenumber up to

$${k}_{max} = \frac{1}{2} \frac{π}{Δ x} \qquad ( 1 )$$

where Δx is the space sampling. For instance, if the input dataset is in a common receiver gather domain, Δx coincides with the inline source sampling. Phase sequencing operates in the Fourier two-dimensional space f−kₓ, where f and kₓ are the conjugate variables of time and source distance, respectively. An illustration of this is depicted in FIGS. 1J and 1K. This example highlights the maximum absolute value of the wavenumber that can be separated or resolved is 0.01 [l/m], which is half the Nyquist wavenumber in this example where the space sampling is 25 m. In particular, FIGS. 1J and 1K illustrate representations in the frequency-wavenumber domain of a phase encoded event.

In contrast to the method of phase sequencing, examples of the disclosed techniques operate in the f−kₓ−k_{y} domain or, equivalently for a fixed frequency, in the kₓ−k_{y} domain. In particular, examples of the disclosed techniques enable the deterministic and/or non-deterministic separation of plane wave event data up to

$${k}_{max} = \frac{1}{2} \sqrt{{( \frac{π}{Δ x} )}^{2} + {( \frac{π}{Δ y} )}^{2}} , \qquad ( 2 )$$

which, in the case of Δx=Δy yields

$${k}_{max} = \frac{\sqrt{2}}{2} \frac{π}{Δ x} , \qquad ( 3 )$$

which is about 40% more than the event number value in equation 1.

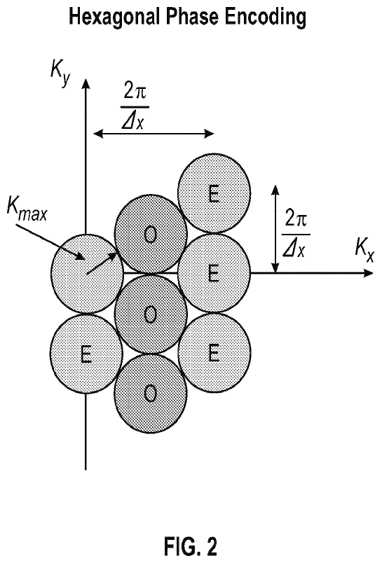

FIG. 2 is a schematic representation in kₓ−k_{y} of signals emitted by two sources sweeping at various locations according to some embodiments. In particular, FIG. 2 shows a schematic representation of the signals obtained by the disclosed method based on hexagonal phase encoding, in the kₓ−k_{y} domain. The bandlimited circular shape of their representation is a feature of the seismic propagation. The green and blue colors denote the signals from the two sources in this example. Separability or resolvability between the two signals from the two sources requires that the green and blue circles do not overlap. This condition and trigonometric considerations enable the determination of the maximum wavenumber that can be separated as expressed in equation 2. The non-overlap condition between the representation in the wavenumber domain of the signals from source 1 and source 1 permits the determination of the maximum wavenumber required for said separation of plane wave event data.

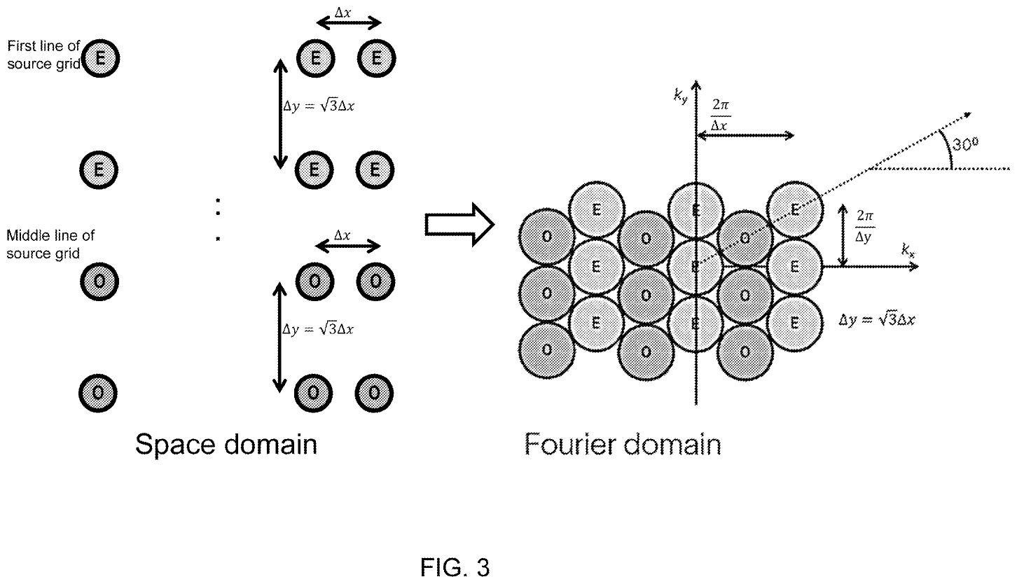

Examples of the methods described herein are directed in part to the acquisition of data (e.g., seismic event data indicating plane wave event data) using marine vibrators in order to obtain a signal representation as depicted in in FIG. 2. Since the signals are sampled, the replicas of the baseband signals (e.g., range of frequencies occupied by desired seismic signal that has not been modulated to higher frequencies) can be represented as well. This may be based on a property of the plane wave domain (e.g., multidimensional Fourier transform) that enables a translation in the kₓ−k_{y} to correspond to a multiplication by a complex exponential in the space domain. Moreover, a multiplication by a complex exponential can be obtained by phase encoding with marine vibrators. Two possible sequences for signals used to drive the “green” and “blue” sources are using normalized source locations characterized by the relationship:

$${S}_{g} = S ( t ) \qquad ( 4 )$$

$$and$$

$${S}_{b} = S ( t ) exp ( i ( π {x}_{v} + π {y}_{v} ) ) , \qquad ( 5 )$$

where xᵥ=0,1 . . . nx−1 and yv=0,1 . . . ny−1. It is appreciated that S(t), according to some embodiments, is the nominal (or reference) sweep used to drive the marine vibrators. If these signals are used to drive the vibrators on the left-hand side of FIG. 3, the signals on the right-hand side of FIG. 3 are obtained as a result.

FIG. 3 illustrates a schematic representation of the elements of an example of the method described herein. On the left is a schematic representation of the vibrator locations. Sailing lines are from left to right. The green vibrator array is installed on a vessel which is separated vertically from the blue vibrator installed on another vessel. The right-hand side of this figure is the representation of the signals in the f−kₓ−k_{y} domain that is obtained if the hexagonal phase encoding scheme described herein is used.

If a representation as the one depicted in FIG. 2 is obtained, the separation between signals of the “green” and “blue” sources can be obtained with one or more circularly shaped 2-dimensional filters for each frequency.

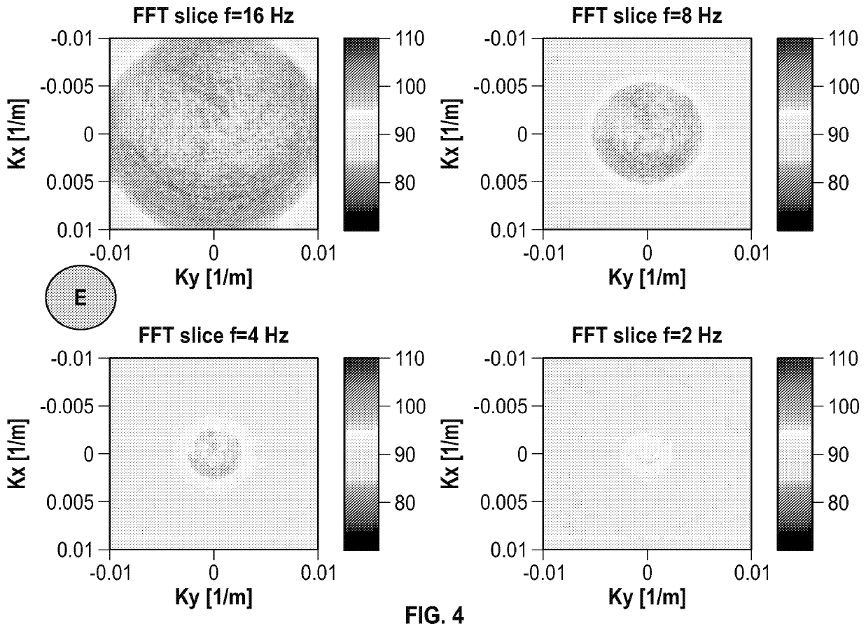

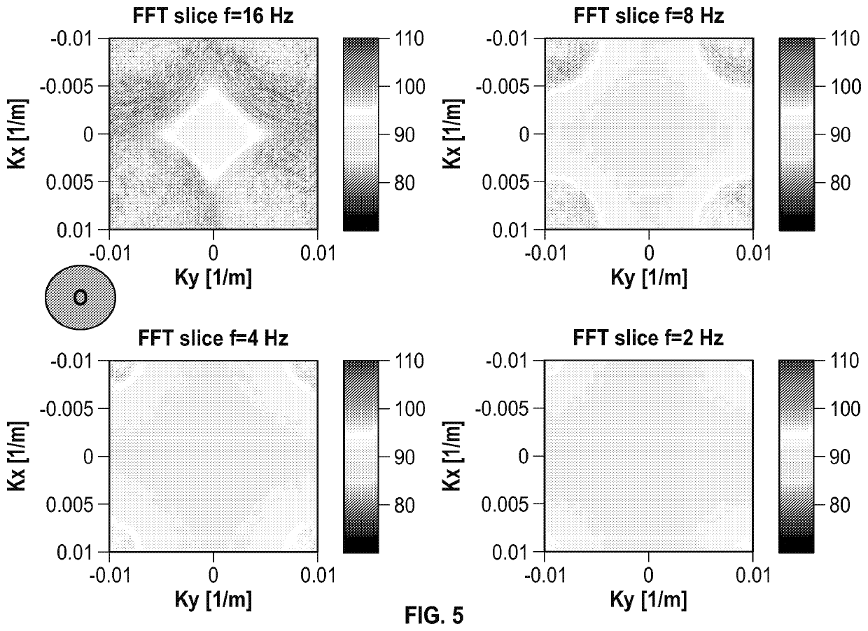

For some examples, the disclosed technique uses a finite-difference acoustic dataset modeled using a SEG-SEAM salt model to demonstrate the hexagonal phase encoding scheme described herein. A source grid of 20×20 kilometers (km) with a space interval of 50×50 meters (m) has been tested or validated using two or more sources, according to some examples. The two or more sources, which can be thought of as marine vibrator arrays installed on two or more vessels, move from left to right with a vertical separation of 10 km. FIG. 4 illustrates (in kₓ−k_{y} domain) the signals recorded by a common receiver gather or detections in the middle of the source grid for the “green” Sg sources, according to an example. Signals in the f−kₓ−k_{y} domain may be obtained from the green sources in FIG. 3 when they are driven with the signals of equation 4. A few constant frequency slices are shown hence the two-dimensional depictions. Similarly, FIG. 5 illustrates the frequency slices when the signals are emitted by the “blue” source according to the phase encoding scheme in equation 5, according to an example. Signals in the f−kₓ−k_{y} domain may be obtained from the blue sources in FIG. 3 when driven with the signals of equation 5. As illustrated in the top-right panels of these two figures, the recorded energy for frequencies up 8.6 Hz are well separated for the green and blue sources.

### Exemplary Workflow

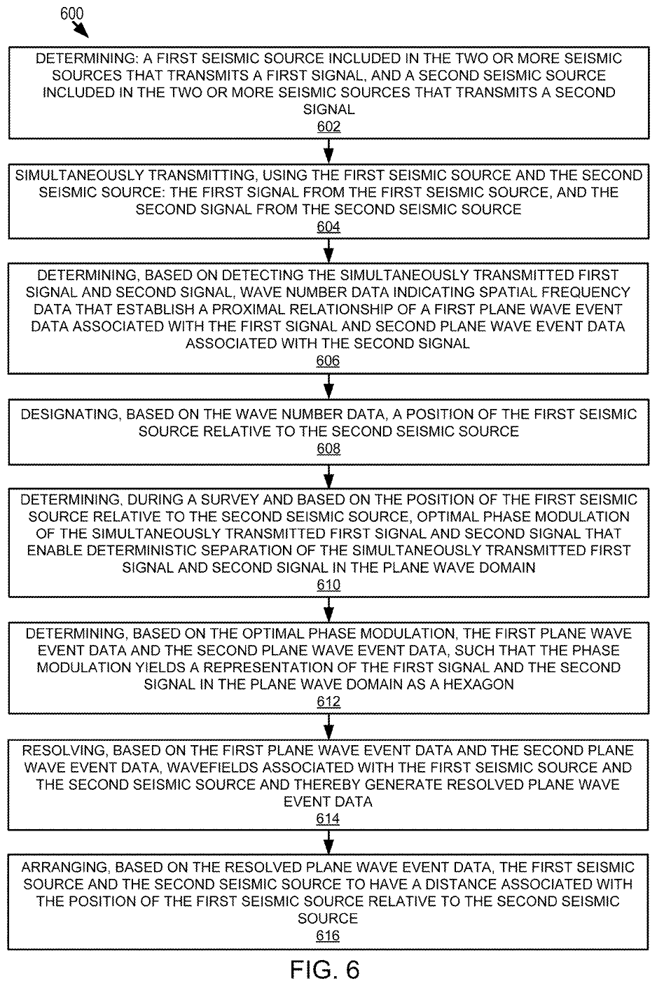

FIG. 6 provides an exemplary detailed workflow 600 for methods, systems, and computer programs that facilitate arranging two or more seismic sources to separate wavefields generated therefrom. It is appreciated that a signal processing engine stored in a memory device (e.g., transitory or non-transitory memory) may cause a computer processor to execute one or more of the various processing stages of the workflows discussed herein. For example, the disclosed techniques may be implemented as signal processing engine within a geological software tool such that the signal processing engine enables, supports, or facilitates arranging two or more seismic sources to separate wavefields generated therefrom based on the processes outlined in this disclosure.

At block 602, the signal processing engine determines: a first seismic source included in the two or more seismic sources that transmits a first signal; and a second seismic source included in the two or more seismic sources that transmits a second signal. Turning to block 604, the signal processing engine can facilitate simultaneously transmitting, using the first seismic source and the second seismic source: the first signal from the first seismic source; and the second signal from the second seismic source. Furthermore, the signal processing engine may determine, at block 606 based on detecting the simultaneously transmitted first signal and second signal, wave number data indicating spatial frequency data that establish a proximal relationship of/or between first plane wave event data associated with the first signal and second plane wave event data associated with the second signal. The proximal relationship, according to some embodiments, comprises a separation distance between the first seismic source and the second seismic source. In some embodiments, the spatial frequency data comprises: first space sampling data (e.g., Δx) associated with a first dimension of a plane wave domain; and second space sampling data (e.g., Δy) associated with a second dimension of the plane wave domain. Moreover, the signal processing engine may facilitate designating, at block 608 based on the wave number data, a position of the first seismic source relative to the second seismic source. In exemplary implementations, the signal processing engine may facilitate determining, at block 610, during a survey and based on the position of the first seismic source relative to the second seismic source, optimal phase modulation (e.g., phase modulation data) of the simultaneously transmitted first signal and second signal that enable deterministic separation of the simultaneously transmitted first signal and second signal in the plane wave domain. Moreover, the signal processing engine may be used to facilitate determining, at block 612 based on the optimal phase modulation, the first plane wave event data and the second plane wave event data, such that the phase modulation indicates a or non-deterministic representation of the first signal and the second signal in the plane wave domain as a hexagon. In some embodiments, the signal processing engine may be used to resolve, at block 614, based on the first plane wave event data and the second plane wave event data, wavefields associated with the first seismic source and the second seismic source and thereby generate resolved plane wave event data. The signal processing engine may guide or otherwise direct arranging, at block 616, based on the resolved plane wave event data, the first seismic source and the second seismic source to have a distance (e.g., separation distance discussed above) associated with the position of the first seismic source relative to the second seismic source.

These and other implementations may each optionally include one or more of the following features. In some embodiments, the first seismic source and the second seismic source comprise vibrators used for seismic exploration. Moreover, the vibrators can comprise land-based vibrators and/or marine vibrators.

The plane wave domain (e.g., a three-dimensional domain), in exemplary implementations comprises: a domain indicating a three-dimensional Fourier transform of the detected simultaneously transmitted first signal and second signal; or constant frequency slices (e.g., two-dimensional slices or a double wave number domain referenced herein as kₓ−k_{y} domain) of the three-dimensional Fourier transform. It is appreciated that the plane wave domain comprises one of a Fourier domain (e.g., a multidimensional Fourier transform) or a Radon domain (e.g., a multidimensional Radon transform). In some embodiments, all seismic sources comprised in the two or more seismic sources are configured such that their representation in the plane wave domain is hexagonal in structure. In addition, the distance associated with the position of the first seismic source relative to the second seismic source is determined based on a separation threshold value that optimizes resolving the first plane wave event data associated with the first signal relative to the second plane wave event data associated with the second signal. Furthermore, the separation threshold value may be determined based on simultaneously transmitting a plurality of signals including the first signal and the second signal from the two or more seismic sources. In some cases, the separation threshold value indicates a number of resolvable plane wave event data associated with the first seismic source and the second seismic source. In addition, the first space sampling data comprises a first space sampling value (e.g., Δx) that is equivalent (e.g., (Δx=Δy) or (Δx=\sqrt{3}Δy) or (\sqrt{3}Δx=Δy)) to a second space sampling value (e.g., Δy) comprised in the second space sampling data. In such cases, the separation threshold value (e.g., kₘₐₓ) indicates a maximum number of resolvable plane wave event data associated with the two or more seismic sources.

In some embodiments, the first seismic source is comprised in a first marine vibrator array coupled to a first vessel while the second seismic source is coupled to a second marine vibrator array coupled to a second vessel. In other embodiments, the first seismic source and the second seismic source are coupled to the same vessel.

Furthermore, the detected simultaneously transmitted first signal and second signal can comprise seismic data captured as part of energy development operations. For example, the seismic data may be comprised in the resolved plane wave event data which may be associated with a resource site including oil fields, oil basis, gas reservoirs, or other characterizations of resources in the subsurface. In exemplary implementations, the flow chart of FIG. 6 may further include modeling a subsurface of a resource site using the resolved plane wave event data to generate a multi-dimensional visualization of the subsurface of the resource site.

It is appreciated that the disclosed approach beneficially enables simultaneously activating and/or actuating and/or transmitting signals (e.g., chirp signals, baseband seismic information seeking signals, etc.) from a plurality of seismic sources all at once as well as extracting relevant seismic information therefrom without information losses due to bandwidth or interference issues. In particular, the disclosed approach facilitates the simultaneous acquisition of a plurality of simultaneously transmitted seismic data thereby speeding acquisition times for said plurality of seismic data and minimizing costs associated with said acquisition of said plurality of seismic data. This beneficially enhances or otherwise optimizes or rather, speeds up geological modeling operations associated with said plurality of seismic data (e.g., resolved seismic data) for energy development operations, for example. According to some embodiments, the disclosed solution facilitates simultaneous acquisition of offshore seismic; simultaneous acquisition of onshore seismic data; and simultaneous acquisition of offshore and onshore vertical seismic profile data.

The steps in the processing methods described above may be implemented by running one or more functional modules in information processing apparatus such as general-purpose processors or application specific chips, such as ASICs, FPGAs, PLDs, or other appropriate devices. These modules, combinations of these modules, and/or their combination with general hardware are included within the scope of this disclosure.

Of course, many processing techniques for collected data, including one or more of the techniques and methods disclosed herein, may also be used successfully with collected data types other than seismic or other subsurface modeling data. While certain implementations have been disclosed in the context of seismic or other subsurface data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Some examples of equations and mathematical expressions may have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to explain the principles of this disclosure and its practical applications, to thereby enable others skilled in the art to use the disclosed approach and various embodiments with various modifications as are suited to the particular use contemplated.

What is claimed is:

1. A method for arranging two or more seismic sources to separate wavefields generated therefrom, the method comprising:
determining:
a first seismic source included in the two or more seismic sources that transmits a first signal, and
a second seismic source included in the two or more seismic sources that transmits a second signal;
simultaneously transmitting, using the first seismic source and the second seismic source:
the first signal from the first seismic source, and
the second signal from the second seismic source;
determining, based on detecting the simultaneously transmitted first signal and second signal, wave number data indicating spatial frequency data that establish a proximal relationship of first plane wave event data associated with the first signal and second plane wave event data associated with the second signal, wherein the spatial frequency data includes:
first space sampling data associated with a first dimension of a plane wave domain, and
second space sampling data associated with a second dimension of the plane wave domain;
designating, based on the wave number data, a position of the first seismic source relative to the second seismic source;
determining, during a survey and based on the position of the first seismic source relative to the second seismic source, optimal phase modulation of the simultaneously transmitted first signal and second signal that enable deterministic separation of the simultaneously transmitted first signal and second signal in the plane wave domain;
determining, based on the optimal phase modulation, the first plane wave event data and the second plane wave event data, such that the phase modulation yields a representation of the first signal and the second signal in the plane wave domain as a hexagon;
resolving, based on the first plane wave event data and the second plane wave event data, wavefields associated with the first seismic source and the second seismic source and thereby generate resolved plane wave event data; and
arranging, based on the resolved plane wave event data, the first seismic source and the second seismic source to have a distance associated with the position of the first seismic source relative to the second seismic source.

2. The method of claim 1, wherein the first seismic source and the second seismic source include vibrators used for seismic exploration.

3. The method of claim 2, wherein the vibrators include marine vibrators.

4. The method of claim 1, wherein the plane wave domain includes:
a domain indicating a three-dimensional Fourier transform of the detected simultaneously transmitted first signal and second signal; or
constant frequency slices of the three-dimensional Fourier transform.

5. The method of claim 4, wherein the plane wave domain is a multidimensional Fourier transform or a Radon multidimensional transform.

6. The method of claim 1, wherein:
all seismic sources included in the two or more seismic sources are configured such that their representation in the plane wave domain is hexagonal in structure;
the distance associated with the position of the first seismic source relative to the second seismic source is determined based on a separation threshold value that optimizes resolving the first plane wave event data associated with the first signal relative to the second plane wave event data associated with the second signal; and
the separation threshold value is determined based on simultaneously transmitting a plurality of signals including the first signal and the second signal from the two or more seismic sources.

7. The method of claim 6, wherein the separation threshold value indicates a number of resolvable plane wave event data associated with the first seismic source and the second seismic source.

8. The method of claim 6, wherein:
the first space sampling data includes a first space sampling value that is equivalent to a second space sampling value included in the second space sampling data; and
the separation threshold value indicates a maximum number of resolvable plane wave event data associated with the two or more seismic sources.

9. The method of claim 1, wherein:
the first seismic source is included in a first marine vibrator array coupled to a first vessel; and
the second seismic source is coupled to a second marine vibrator array coupled to a second vessel.

10. The method of claim 1, wherein the first seismic source and the second seismic source are coupled to the same vessel.

11. The method of claim 1, wherein the detected simultaneously transmitted first signal and second signal includes seismic data.

12. The method of claim 1, comprising modeling a subsurface of a resource site using the resolved plane wave event data to generate a multi-dimensional visualization of the subsurface of the resource site.

13. A system for arranging two or more seismic sources to separate wavefields generated therefrom, the system comprising:
a computer processor; and
memory storing instructions that are executable by the computer processor to:
determine:
a first seismic source included in the two or more seismic sources that transmits a first signal, and
a second seismic source included in the two or more seismic sources that transmits a second signal;
simultaneously transmit, using the first seismic source and the second seismic source:
the first signal from the first seismic source, and
the second signal from the second seismic source;
determine, based on detecting the simultaneously transmitted first signal and second signal, wave number data indicating spatial frequency data that establish a proximal relationship of first plane wave event data associated with the first signal and second plane wave event data associated with the second signal, wherein the spatial frequency data includes:
first space sampling data associated with a first dimension of a plane wave domain, and
second space sampling data associated with a second dimension of the plane wave domain;
designate, based on the wave number data, a position of the first seismic source relative to the second seismic source;
determine, during a survey and based on the position of the first seismic source relative to the second seismic source, optimal phase modulation of the simultaneously transmitted first signal and second signal that enable deterministic separation of the simultaneously transmitted first signal and second signal in the plane wave domain;
determine, based on the optimal phase modulation, the first plane wave event data and the second plane wave event data, such that the phase modulation indicates a representation of the first signal and the second signal in the plane wave domain as a hexagon;
resolve, based on the first plane wave event data and the second plane wave event data, wavefields associated with the first seismic source and the second seismic source and thereby generate resolved plane wave event data; and
arrange, based on the resolved plane wave event data, the first seismic source and the second seismic source to have a distance associated with the position of the first seismic source relative to the second seismic source.

14. The system of claim 13, wherein the plane wave domain includes:
a domain indicating a three-dimensional Fourier transform of the detected simultaneously transmitted first signal and second signal; or
constant frequency slices of the three-dimensional Fourier transform.

15. The system of claim 13, wherein:
the distance associated with the position of the first seismic source relative to the second seismic source is determined based on a separation threshold value that optimizes resolving the first plane wave event data associated with the first signal relative to the second plane wave event data associated with the second signal; and
the separation threshold value indicates a number of resolvable plane wave event data associated with the first seismic source and the second seismic source.

16. The system of claim 13, wherein
the first space sampling data includes a first space sampling value that is equivalent to a second space sampling value included in the second space sampling data; and
the separation threshold value indicates a maximum number of resolvable plane wave event data associated with the two or more seismic sources.

17. A computer program comprising instructions for arranging two or more seismic sources to separate wavefields generated therefrom, that when executed by a computer processor of a computing device, causes the computing device to:
determine:
a first seismic source included in the two or more seismic sources that transmits a first signal, and
a second seismic source included in the two or more seismic sources that transmits a second signal;
simultaneously transmit, using the first seismic source and the second seismic source:
the first signal from the first seismic source, and
the second signal from the second seismic source;
determine, based on detecting the simultaneously transmitted first signal and second signal, wave number data indicating spatial frequency data that establish a proximal relationship of first plane wave event data associated with the first signal and second plane wave event data associated with the second signal, wherein the spatial frequency data includes:
first space sampling data associated with a first dimension of a plane wave domain, and
second space sampling data associated with a second dimension of the plane wave domain;
designate, based on the wave number data, a position of the first seismic source relative to the second seismic source;
determine, during a survey and based on the position of the first seismic source relative to the second seismic source, optimal phase modulation of the simultaneously transmitted first signal and second signal that enable deterministic separation of the simultaneously transmitted first signal and second signal in the plane wave domain;
determine, based on the optimal phase modulation, the first plane wave event data and the second plane wave event data, such that the phase modulation indicates a representation of the first signal and the second signal in the plane wave domain as a hexagon;
resolve, based on the first plane wave event data and the second plane wave event data, wavefields associated with the first seismic source and the second seismic source and thereby generate resolved plane wave event data; and
arrange, based on the resolved plane wave event data, the first seismic source and the second seismic source to have a distance associated with the position of the first seismic source relative to the second seismic source.

18. The computer program of claim 17, wherein the plane wave domain includes:
a domain indicating a three-dimensional Fourier transform of the detected simultaneously transmitted first signal and second signal; or
constant frequency slices of the three-dimensional Fourier transform.

19. The computer program of claim 17, wherein:
the distance associated with the position of the first seismic source relative to the second seismic source is determined based on a separation threshold value that optimizes resolving the first plane wave event data associated with the first signal relative to the second plane wave event data associated with the second signal; and
the separation threshold value indicates a number of resolvable plane wave event data associated with the first seismic source and the second seismic source.

20. The computer program of claim 19, wherein:
the first space sampling data includes a first space sampling value that is equivalent to a second space sampling value included in the second space sampling data; and
the separation threshold value indicates a maximum number of resolvable plane wave event data associated with the two or more seismic sources.
